(19) United States
(12) Patent Application Publication
(10) Pub. No.: US 2014/0076034 A1
(43) Pub. Date: Mar. 20, 2014

(54) TESTING FIXTURE AND TESTING METHOD

(71) Applicant: ASKEY COMPUTER CORP., NEW TAIPEI CITY (TW)

(72) Inventor: Kuang-Chen Wu, New Taipei City (TW)

(73) Assignee: ASKEY COMPUTER CORP., NEW TAIPEI CITY (TW)

(21) Appl. No.: 13/760,013

(22) Filed: Feb. 5, 2013

(30) Foreign Application Priority Data
Sep. 14, 2012 (TW) 101133838

(51) Int. Cl. G01M 3/20

(52) U.S. Cl. CPC G01M 3/20
USPC 73/40.7

(57) ABSTRACT

A testing fixture and a testing method are provided. The testing fixture is configured to be assembled to an accommodating space of an electronic device. The testing fixture has a connector configured to communicate a gas controlling apparatus. The gas controlling apparatus controls the gas pressure inside the electronic device through the connector and the testing fixture, so as to perform a gasproof test.

### CROSS-REFERENCE TO RELATED APPLICATION

This application claims the priority benefit of Taiwan application serial no. 101133838, filed on Sep. 14, 2012. The entirety of the above-mentioned patent application is hereby incorporated by reference herein and made a part of this specification.

### BACKGROUND

1. Field of the Invention

The invention relates to a testing fixture and a testing method, and more particularly, to a gasproof testing fixture and a gasproof testing method.

2. Description of Related Art

Components inside electronic devices may be damaged because of water infiltration, and as nowadays the electronic devices are finer and more complex, the waterproof requirement also increases gradually. During the research and development or manufacturing process of products, the products have to undergo waterproof tests so as to reach different waterproof levels of the electronic devices; for example, the IPX7 standard is that the electronic device under test is placed in water at a depth of 1 meter for 30 minutes, and water does not enter the electronic device.

A conventional waterproof test for the electronic device is to randomly sample and place the electronic device under test into water directly for a certain period of time, then take the electronic device out, and disassemble the electronic device under test to inspect if there are moisture welts or remaining water in the interior of the electronic device. Therefore, when the electronic device under test fails to pass the waterproof test, water infiltrate into the interior of the electronic device under test and causes damage. In addition, the electronic device has to be re-assembled after inspection, and whether the assembly quality is good or whether the original waterproof structure is damaged during the assembly process remains undetermined. When the electronic device under test is a product to be sold to clients or sold on markets, the product with poor yield is more likely to result in a bad impression on the clients. Furthermore, the method is only applicable in a small amount of testing in the initial research and development stage or in the sampling inspection of the products in mass production; therefore, the method cannot ensure that products that have not been tested have the same waterproof effect as products that have been tested.

### SUMMARY OF THE INVENTION

The invention provides a testing fixture and a testing method thereof which are able to ensure that each electronic device is waterproof and prevent the yield from decreasing because of disassembly of the electronic device during a testing process.

The testing fixture of the invention is configured to be assembled to an accommodating space of an electronic device. The testing fixture has a connector configured to communicate a gas controlling apparatus. The gas controlling apparatus controls the gas pressure inside the electronic device through the testing fixture, so as to perform a gasproof test.

In an embodiment of the testing fixture of the invention, in a working state of the electronic device, the accommodating space accommodates a removable element of the electronic device.

In an embodiment of the testing fixture of the invention, the removable element is a battery.

In an embodiment of the testing fixture of the invention, the gas controlling apparatus is a vacuum compressor.

In an embodiment of the testing fixture of the invention, a structure of a portion at which the testing fixture is combined with the electronic device is the same as a structure of a corresponding portion of the removable element.

The testing method of the invention includes the following steps. A testing fixture is assembled to an accommodating space of an electronic device. The testing fixture has a connector. The connector communicates an gas controlling apparatus. The gas controlling apparatus is operated to control the gas pressure inside the electronic device through the testing fixture, so as to perform a gasproof test.

In an embodiment of the testing method of the invention, water does not enter the electronic device when the electronic device that has passed the gasproof test and assembled with a removable element is placed in water at a depth of 1 meter for 30 minutes.

In an embodiment of the testing method of the invention, the gasproof test includes testing if the gas pressure inside the electronic device may be controlled to decrease to a first gas pressure within a first time. The first time is 20 seconds, for example, and the first gas pressure is 80 torr, for example.

In an embodiment of the testing method of the invention, the gasproof test further includes placing the electronic device together with the testing fixture into water and supplying gas to the electronic device to determine a location where gas leakage occurs according to a location where bubbles generate when the gas pressure inside the electronic device is not decreased to the first gas pressure within the first time.

In an embodiment of the testing method of the invention, the gasproof test further includes testing if the gas pressure inside the electronic device may remain at the first gas pressure within a second time after the gas pressure inside the electronic device is decreased to the first gas pressure. The second time is 10 seconds, for example.

In an embodiment of the testing method of the invention, the gasproof test further includes testing if the difference between the gas pressure inside the electronic device and the first gas pressure keeps within a predetermined value within a third time after the gas pressure inside the electronic device is decreased to the first gas pressure. The third time is 30 seconds, for example, and the predetermined value is 2 torr, for example.

Based on the above, in the testing fixture and the testing method of the invention, the testing fixture replaces the original removable element in the electronic device, so that there is no need to disassemble and assemble fixed portions of the electronic device, thereby ensuring every electronic device is an undefective product.

In order to make the aforementioned features and advantages of the invention more comprehensible, embodiments accompanying figures are described in details below.

### BRIEF DESCRIPTION OF THE DRAWINGS

The accompanying drawings are included to provide further understanding and are incorporated in and constitute a part of this specification. The drawings illustrate exemplary embodiments and, together with the description, serve to explain the principles of the invention.

FIGS. 1A and 1B are views of two different directions of a testing fixture according to an embodiment of the invention.

FIG. 2 is an exploded view of an electronic device under test.

FIG. 3 is a schematic view illustrating the testing fixture of FIG. 1B assembled to the electronic device of FIG. 2.

### DESCRIPTION OF EMBODIMENTS

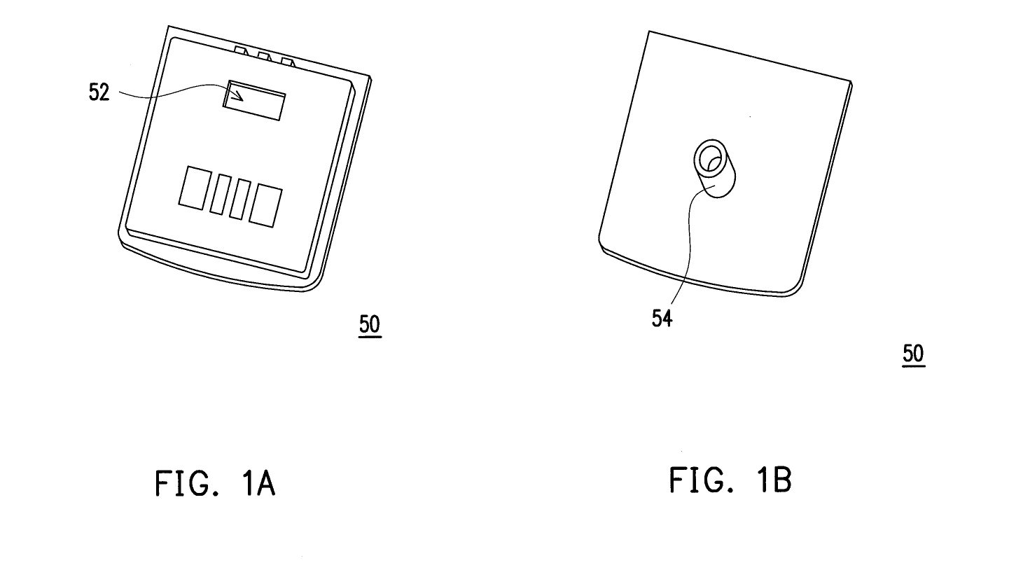

FIGS. 1A and 1B are views of two different directions of a testing fixture according to an embodiment of the invention. Referring to FIGS. 1A and 1B, a testing fixture 50 of the present embodiment has an opening 52 at a side shown in FIG. 1A, and the testing fixture 50 has a connector 54 at a side shown in FIG. 1B. The connector 54 and the opening 52 communicate each other. In other words, gas that enters the testing fixture 50 through the opening 52 may flow out from the connector 54, and vice versa.

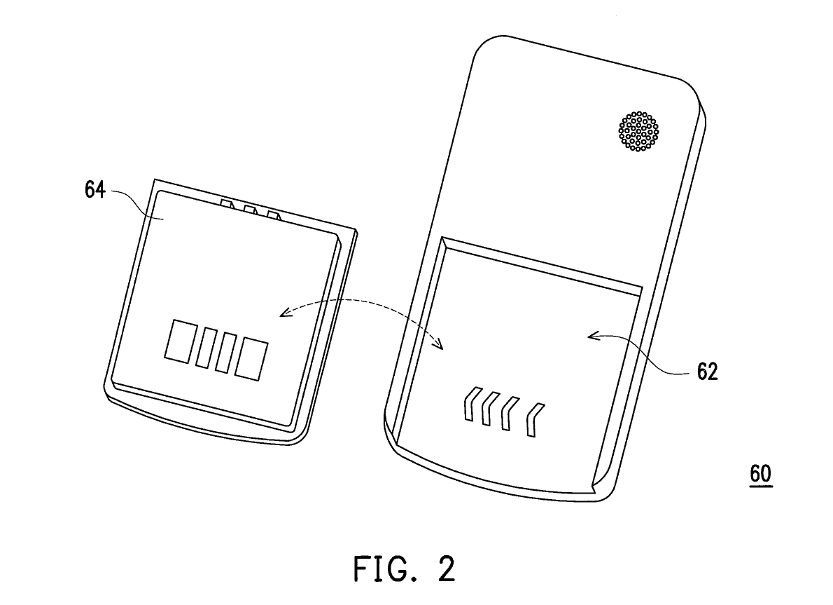

FIG. 2 is an exploded view of an electronic device under test. Referring to FIG. 2, an electronic device 60 has an accommodating space 62 and a removable element 64. In a working state of the electronic device 60, the accommodating space 62 accommodates the removable element 64 (such as a battery). When the electronic device 60 is not in the working state, the removable element 64 may be removed selectively. In other words, the removable element 64 on the electronic device 60 is originally designed to allow users to decide whether to remove the removable element 64 according to needs. When the removable element 64 is assembled to the accommodating space 62, whether the entire electronic device 60 is able to pass the gasproof test of certain conditions is information to be acquired by performing a test with using the testing fixture 50 as shown in FIG. 1B.

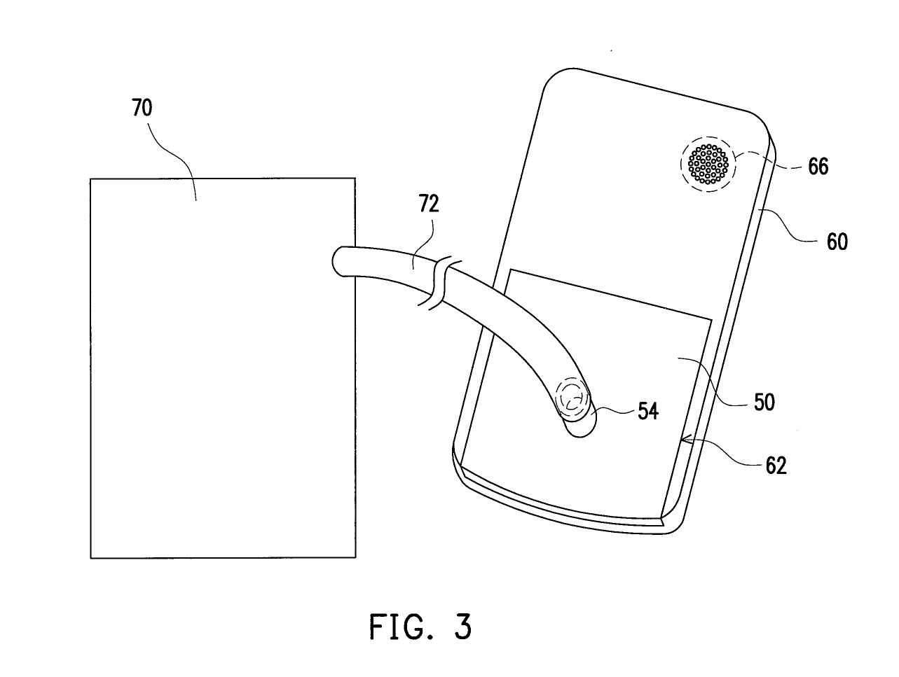

FIG. 3 is a schematic view illustrating the testing fixture of FIG. 1B assembled to the electronic device of FIG. 2. Referring to FIG. 3, when a test is performed, the testing fixture 50 of the present embodiment may be assembled to the accommodating space 62 of the electronic device 60 of FIG. 2. The connector 54 of the testing fixture 50 is configured to communicate a gas controlling apparatus 70. For example, the connector 54 communicates the gas controlling apparatus 70 through a hose 72. The connector 54 may be any kind of commonly seen gas connectors available in the market, and the size of the connector 54 may also be selected according to needs. The gas controlling apparatus 70 controls the gas pressure inside the electronic device 60 through the testing fixture 50, so as to perform a gasproof test.

In light of the above, the testing fixture 50 of the present embodiment replaces the removable element 64 (shown in FIG. 2) that is originally designed to be removable on the electronic device 60; portions designed as fixed portions of the electronic device 60 do not have to be disassembled; and the structure of the electronic device 60 certainly does not have to be destroyed, thereby ensuring the electronic device 60 has a consistent state before and after the test and maintaining the quality in this way.

In the present embodiment, the removable element 64 is a battery. Indeed, the removable element 64 may be other removable elements commonly seen on the electronic device 60, such as an antenna or the like. To ensure that the same gasproof standard is also met when the removable element 64 is assembled back to the electronic device 60 after the test is completed, a structure of a portion at which the testing fixture 50 is combined with the electronic device 60 may be designed to be the same as a structure of a corresponding portion of the removable element 64. For example, a housing of the testing fixture 50 and a housing of the removable element 64 may be the same housing. The gas controlling apparatus 70 of the present embodiment is a vacuum or an gas pump. Indeed, the performance of the gasproof test is not limited to a way of vacuuming, and the test may also be performed by using an gas controlling apparatus of the gas pump to pump the gas into the electronic device 60.

A testing method of an embodiment of the invention is illustrated below, wherein the testing fixture 50 and the electronic device 60 as shown in FIG. 3 are used as an example. However, the testing method of the present embodiment is not limited to using the testing fixture 50 and the electronic device 60 as shown in FIG. 3, and the testing fixture 50 as shown in FIG. 3 is not limited to being used in the testing method of the present embodiment only.

First, the testing fixture 50 is assembled to the accommodating space 62 of the electronic device 60, and the connector 54 is made to communicate the gas controlling apparatus 70. Then, the gas controlling apparatus 70 is operated to control the gas pressure inside the electronic device 60 through the testing fixture 50, so as to perform the gasproof test.

The testing method of the present embodiment is not merely a gasproof test but may also simulate a waterproof test to gain a corresponding waterproof level, such as whether the electronic device 60 meets the IPX7 standard. In this way, when the electronic device 60 has to undergo a waterproof level test, the electronic device 60 does not really have to be placed in water, which avoids the costs caused by the damage of the electronic device 60 when water enters the electronic device 60 and the electronic device 60 has to be scrapped. Specifically, the present embodiment simulates a state that the electronic device 60 withstands water pressure in water by controlling the gas pressure inside the electronic device 60 to be positive or negative relative to an outside environment. For example, a testing purpose of the testing method of the present embodiment may be set as that the electronic device 60 that has passed the test and assembled with the removable element 64 (shown in FIG. 2) may be placed in water at a depth of 1 meter for 30 minutes, and water does not enter the electronic device 60. In other words, the electronic device 60 meets the IPX7 standard.

The gasproof test of the present embodiment includes testing if the gas pressure inside the electronic device 60 may be controlled to decrease to a first gas pressure within a first time. In an example given below, the first time is exemplified as 20 seconds, and the first gas pressure is exemplified as 80 torr, but the invention is not limited thereto. If the gas controlling apparatus 70 is not able to decrease the gas pressure inside the electronic device 60 to 80 torr within 20 seconds, then the electronic device 60 may be determined preliminarily to be unable to pass the gasproof test. At this time, the electronic device 60 may be selectively placed into water together with the testing fixture 50, and the gas controlling apparatus 70 supplies gas to the electronic device 60 so as to determine a location where gas leakage occurs according to a location where bubbles generate.

On the other hand, if the gas controlling apparatus 70 is able to decrease the gas pressure inside the electronic device 60 to 80 torr within 20 seconds, then the electronic device 60 may be determined preliminarily to pass the gasproof test. Selectively, the gas controlling apparatus 70 may be operated continuously to test if the gas pressure inside the electronic device 60 may remain at the first gas pressure (i.e. 80 torr) within a second time after the gas pressure inside the electronic device 60 is decreased to 80 torr. In this way, the gas pressure inside the electronic device 60 is ensured to remain at 80 torr instead of reaching 80 torr temporarily. The second time is 10 seconds, for example, but is not limited thereto.

In addition, after the gas pressure inside the electronic device 60 is decreased to 80 torr or after the gas pressure inside the electronic device 60 remains at 80 torr for 10 seconds, whether the difference between the gas pressure inside the electronic device 60 and 80 torr may remain within a predetermined value within a third time may be tested selectively. Within the third time, the gas controlling apparatus 70 stops operating and only remains in a gasproof state. The third time is 30 seconds, for example, and the predetermined value is 2 torr, for example, but the third time and the predetermined value are not limited thereto. If after the gas controlling apparatus 70 stops operating, the difference between the gas pressure inside the electronic device 60 and 80 torr may remain within 2 torr, then the electronic device 60 is determined to pass the gasproof test.

From the statistics shown in the above examples, the testing method of the present embodiment is able to determine whether the electronic device 60 passes the gasproof test in a maximum testing time of 1 minute, thereby determining whether the waterproof ability of the electronic device 60 meets the IPX7 standard. Therefore, the testing method of the present embodiment shortens the time required by the test significantly and allows each electronic device 60 to undergo the test instead of using sampling inspection. In this way, the reliability of the electronic device 60 is increased greatly.

In addition, a portion of the electronic devices 60 may have the need to transmit sound, and thus there has to be an opening on a surface to facilitate the transmission of the sound. However, to meet the waterproof requirement, an gas-permeable waterproof film 66 is disposed on the opening. Therefore, to replace the waterproof test in which the electronic device 60 is actually placed in water with the gasproof test, the gas has to be prevented from passing through the gas-permeable waterproof film 66. At this time, before the gasproof test is performed, water drops may be used to cover the gas-permeable waterproof film 66 from the outside of the electronic device 60. In this way, when the gas controlling apparatus 70 is used to extract the gas inside the electronic device 60 to decrease the internal gas pressure and perform the gasproof test, the water drops block the gas-permeable waterproof film 66 and prevent the gas from entering the electronic device 60, thereby completing the gasproof test smoothly.

Based on the above, in the testing fixture and the testing method of the invention, the testing fixture replaces the original removable element in the electronic device, which may ensure that every electronic device is an undefective product and avoid disassembling fixed portions of the electronic device during the testing process. In addition, using the gasproof test requiring a shorter testing time to simulate the waterproof test requiring a longer testing time facilitates inspecting the electronic devices one by one and solves the problem that sampling inspection is unable to ensure the reliability of all the products.

Although the invention has been described with reference to the above embodiments, they are not intended to limit the invention. It is apparent to people of ordinary skill in the art that modifications and variations to the invention may be made without departing from the spirit and scope of the invention. In view of the foregoing, the protection scope of the invention will be defined by the appended claims.

What is claimed is:

1. A testing fixture configured to be assembled to an accommodating space of an electronic device, the testing fixture having a connector configured to communicate a gas controlling apparatus, the gas controlling apparatus being operated to control the gas pressure inside the electronic device through the testing fixture, so as to perform a gasproof test.

2. The testing fixture according to claim 1, wherein in a working state of the electronic device, the accommodating space accommodates a removable element of the electronic device.

3. The testing fixture according to claim 2, wherein the removable element is a battery.

4. The testing fixture according to claim 2, wherein a structure of a portion at which the testing fixture is combined with the electronic device is the same as a structure of a corresponding portion of the removable element.

5. A testing method, comprising:
assembling a testing fixture to an accommodating space of an electronic device, the testing fixture having a connector;
making the connector communicate an gas controlling apparatus; and
operating the gas controlling apparatus to control the gas pressure inside the electronic device through the testing fixture, so as to perform a gasproof test.

6. The testing method according to claim 5, wherein water does not enter the electronic device when the electronic device that has passed the gasproof test and assembled with a removable element is placed in water at a depth of 1 meter for 30 minutes.

7. The testing method according to claim 5, wherein the gasproof test comprises:
testing if the gas pressure inside the electronic device is controlled to decrease to a first gas pressure within a first time.

8. The testing method according to claim 7, wherein the first time is 20 seconds, and the first gas pressure is 80 torr.

9. The testing method according to claim 7, wherein the gasproof test further comprises:
placing the electronic device together with the testing fixture into water and supplying gas to the electronic device to determine a location where gas leakage occurs according to a location where bubbles generate when the gas pressure inside the electronic device is not decreased to the first gas pressure within the first time.

10. The testing method according to claim 7, wherein the gasproof test further comprises:
testing if the gas pressure inside the electronic device keeps at the first gas pressure within a second time after the gas pressure inside the electronic device is decreased to the first gas pressure.

11. The testing method according to claim 10, wherein the second time is 10 seconds.

12. The testing method according to claim 7, wherein the gasproof test further comprises:
testing if the difference between the gas pressure inside the electronic device and the first gas pressure keeps within a predetermined value within a third time after the gas pressure inside the electronic device is decreased to the first gas pressure.

13. The testing method according to claim 12, wherein the third time is 30 seconds, and the predetermined value is 2 torr.
